(19) United States
(12) Patent Application Publication
(10) Pub. No.: US 2019/0104199 A1
(43) Pub. Date: Apr. 4, 2019

(54) CROSS DEVICE BANDWIDTH UTILIZATION CONTROL

(71) Applicant: Google Inc., Mountain View, CA (US)

(72) Inventors: Aaron Nathaniel Rothman, Sunnyvale, CA (US); Gaurav Bhaya, Sunnyvale, CA (US); Robert Stets, Mountain View, CA (US)

(73) Assignee: Google Inc., Mountain View, CA (US)

(21) Appl. No.: 15/638,295

(22) Filed: Jun. 29, 2017

Related U.S. Application Data
(63) Continuation-in-part of application No. 13/441,298, filed on Apr. 6, 2012, now Pat. No. 9,922,334.
Application No. 13/441,298 is a continuation-in-part of application No. 15/395,703, filed on Dec. 30, 2016, now Pat. No. 10,032,452.

(51) Int. Cl. H04L 29/08; H04L 12/26; G06F 17/30

(52) U.S. Cl. CPC H04L 67/327; G06F 17/30401; H04L 43/0805

(57) ABSTRACT

A system of multi-modal transmission of packetized data in a voice activated data packet based computer network environment is provided. A natural language processor component can parse an input audio signal to identify a request and a trigger keyword. Based on the input audio signal, a direct action application programming interface can generate a first action data structure, and a content selector component can select a content item based on a count reaches a target number. An interface management component can identify first and second candidate interfaces, and respective resource utilization values. The interface management component can select, based on the resource utilization values, the first candidate interface to present the content item.

### CROSS-REFERENCE TO RELATED APPLICATIONS

The present application claims the benefit of priority under 35 U.S.C. § 120 as a continuation-in-part of U.S. patent application Ser. No. 13/441,298, filed Apr. 6, 2012. The present application also claims the benefit of priority under 35 U.S.C. § 120 as a continuation-in-part of U.S. patent application Ser. No. 15/395,703, filed Dec. 30, 2016. Each of the foregoing applications is hereby incorporated by reference in their entirety.

### BACKGROUND

Excessive network transmissions, packet-based or otherwise, of network traffic data between computing devices can prevent a computing device from properly processing the network traffic data, completing an operation related to the network traffic data, or timely responding to the network traffic data. The excessive network transmissions of network traffic data can also complicate data routing or degrade the quality of the response if the responding computing device is at or above its processing capacity, which may result in inefficient bandwidth utilization. The control of network transmissions corresponding to content item objects can be complicated by the large number of content item objects that can initiate network transmissions of network traffic data between computing devices.

### SUMMARY

At least one aspect of the disclosure is directed to a system to provide content to computing devices in an online computer network environment. The system includes a data processing system to receive an audio-based request from a computing device. The audio-based request can include a device identifier associated with the computing device. The audio-based request can be detected at the computing device. The data processing system can receive selection criteria that can include device identifier characteristics. The selection criteria can be associated with a digital component. The data processing system can identify a plurality of digital components associated with a digital component. The data processing system can determine a count representing a number of the plurality of digital components previously transmitted to the computing device. The data processing system can receive a target number of the plurality of digital components previously transmitted to the computing device. The data processing system can determine a probability the count reaches the target number within a predetermined time interval. The data processing system can select a candidate digital component based on the probability and selection criteria. The data processing system can transmit the candidate digital component to the computing device.

At least one aspect of the disclosure is directed to a method to provide content to computing devices in an online computer network environment. The method can include receiving, by a data processing system, an audio-based request from a computing device. The audio-based request can include a device identifier that can be associated with the computing device. The audio-based request can be detected at the computing device. The method can include receiving, by the data processing system, selection criteria that can include device identifier characteristics. The selection criteria can be associated with a digital component. The method can include identifying, by the data processing system, a plurality of digital components associated with the digital component. The method can include determining, by the data processing system, a count representing a number of the plurality of digital components previously transmitted to the computing device. The method can include receiving, by the data processing system, a target number of the plurality of digital components previously transmitted to the computing device. The method can include determining, by the data processing system, a probability the count reaches the target number within a predetermined time interval. The method can include selecting, by the data processing system, a candidate digital component based on the probability and selection criteria. The method can include transmitting, by the data processing system, the candidate digital component to the computing device.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1A is an example of a block diagram of a computer system in accordance with a described implementation.

FIG. 1B depicts a system to of multi-modal transmission of packetized data in a voice activated computer network environment;

FIG. 1C depicts a flow diagram for multi-modal transmission of packetized data in a voice activated computer network environment;

FIG. 2 is an illustration of an example system for serving digital components in accordance with a described implementation.

FIG. 3 is an illustration of an example interface for a service provider in accordance with a described implementation.

FIG. 4 is an example of a system for updating the device identifier in accordance with a described implementation.

FIG. 5 is an example of a flow diagram for serving digital components in accordance with a described implementation.

FIG. 6 is a block diagram illustrating an example method to provide digital components in an online computer network.

FIG. 7 is a block diagram illustrating a general architecture for a computer system that may be employed to implement elements of the systems and methods described and illustrated herein.

Like reference numbers and designations in the various drawings indicate like elements.

### DETAILED DESCRIPTION

Following below are more detailed descriptions of various concepts related to, and implementations of, methods, apparatuses, and systems for multi-modal transmission of packetized data in a voice activated data packet based computer network environment. The various concepts introduced above and discussed in greater detail below may be implemented in any of numerous ways.

Systems and methods of the present disclosure relate generally to a data processing system that identifies an optimal transmission modality for data packet (or other protocol based) transmission in a voice activated computer network environment. The data processing system can improve the efficiency and effectiveness of data packet transmission over one or more computer networks by, for example, selecting a transmission modality from a plurality of options for data packet routing through a computer network of content items to one or more client computing device, or to different interfaces (e.g., different apps or programs) of a single client computing device. In some implementations, digital components are transmitted to and displayed by computing device a predetermined number of times to achieve an outcome. For example, a digital component (or a group of related digital components) may need to be displayed five times within a given time interval such that a user remembers the subject matter of the digital components. Content items can also be referred to as digital components. In some implementations, a digital component can be a component of a content item. The data processing system can also improve the efficiency and effectiveness of the data packet transmissions over one of more computer networks by, for example, determining not to transmit digital components to a computing device. For example, the data processing system can select to not transmit a digital component to a computing device, and save bandwidth and computational resources, if the data processing system determines the digital component will not be display the predetermined number of times to achieve the outcome. The data processing system can also select digital components such that the digital components are presented the predetermined number of times, such that bandwidth is not wasted by transmitted digital components that have little chance of reaching the predetermined number of exposure times.

Data packets or other protocol based signals corresponding to the selected operations can be routed through a computer network between multiple computing devices. For example, the data processing system can route a content item to a different interface than an interface from which a request was received. The different interface can be on the same client computing device or a different client computing device from which a request was received. The data processing system can select at least one candidate interface from a plurality of candidate interfaces for content item transmission to a client computing device. The candidate interfaces can be determined based on technical or computing parameters such as processor capability or utilization rate, memory capability or availability, battery status, available power, network bandwidth utilization, interface parameters or other resource utilization values. By selecting an interface to receive and provide the content item for rendering from the client computing device based on candidate interfaces or utilization rates associated with the candidate interfaces, the data processing system can reduce network bandwidth usage, latency, or processing utilization or power consumption of the client computing device that renders the content item. This saves processing power and other computing resources such as memory, reduces electrical power consumption by the data processing system and the reduced data transmissions via the computer network reduces bandwidth requirements and usage of the data processing system.

The systems and methods described herein can include a data processing system that receives an input audio query, which can also be referred to as an input audio signal. From the input audio query the data processing system can identify a request and a trigger keyword corresponding to the request. Based on the trigger keyword or the request, the data processing system can generate a first action data structure. For example, the first action data structure can include an organic response to the input audio query received from a client computing device, and the data processing system can provide the first action data structure to the same client computing device for rendering as audio output via the same interface from which the request was received.

The data processing system can also select at least one content item based on the trigger keyword or the request. The data processing system can identify or determine a plurality of candidate interfaces for rendering of the content item(s). The interfaces can include one or more hardware or software interfaces, such as display screens, audio interfaces, speakers, applications or programs available on the client computing device that originated the input audio query, or on different client computing devices. The interfaces can include java script slots for online documents for the insertion of content items, as well as push notification interfaces. The data processing system can determine utilization values for the different candidate interfaces. The utilization values can indicate power, processing, memory, bandwidth, or interface parameter capabilities, for example. Based on the utilization values for the candidate interfaces the data processing system can select a candidate interface as a selected interface for presentation or rendering of the content item. For example, the data processing system can convert or provide the content item for delivery in a modality compatible with the selected interface. The selected interface can be an interface of the same client computing device that originated the input audio signal or a different client computing device. By routing data packets via a computing network based on utilization values associated with a candidate interface, the data processing system selects a destination for the content item in a manner that can use the least amount of processing power, memory, or bandwidth from available options, or that can conserve power of one or more client computing devices.

The data processing system can provide the content item or the first action data structure by packet or other protocol based data message transmission via a computer network to a client computing device. The output signal can cause an audio driver component of the client computing device to generate an acoustic wave, e.g., an audio output, which can be output from the client computing device. The audio (or other) output can correspond to the first action data structure or to the content item. For example, the first action data structure can be routed as audio output, and the content item can be routed as a text based message. By routing the first action data structure and the content item to different interfaces, the data processing system can conserve resources utilized by each interface, relative to providing both the first action data structure and the content item to the same interface. This results in fewer data processing operations, less memory usage, or less network bandwidth utilization by the selected interfaces (or their corresponding devices) than would be the case without separation and independent routing of the first action data structure and the content item.

Service Providers can determine goals for exposure to certain digital components or groups of digital components within their content campaigns. Service Providers may also determine a strategy for what times to serve the digital components to meet their goals for exposure. The strategy may be based on previous exposures of the digital components to the users.

The exposures may be determined by a number of devices, e.g., a set-top box, a television, a web page, etc. used to serve the digital components. The devices may include a database to store the number of exposures and the time of exposure.

Based on the number of exposures of digital components, service providers can determine or update strategies for their proposed, e.g., yet to be served, digital components. For example, service providers concerned with delivering a message believe that users may need to be exposed to the message a minimum number of times, in a given period of time, before the user is aware of the message. Although a click would count as a recognition of the message, clicks are not a reliable source to estimate the minimum number of exposures, e.g., clicks are infrequent and do not acknowledge every time a user is exposed to the message and does not click on the message.

In a general overview, the service provider can determine a minimum number of exposures for an interval of time. The service provider may also determine a maximum aggregate bid value for each user. A digital component server determines the probability that a user will meet the minimum number of exposures within the interval of time. Given the probability, the digital component server adjusts bidding within the service provider's maximum aggregate bid value for each user that meets the minimum number of exposures within the interval of time.

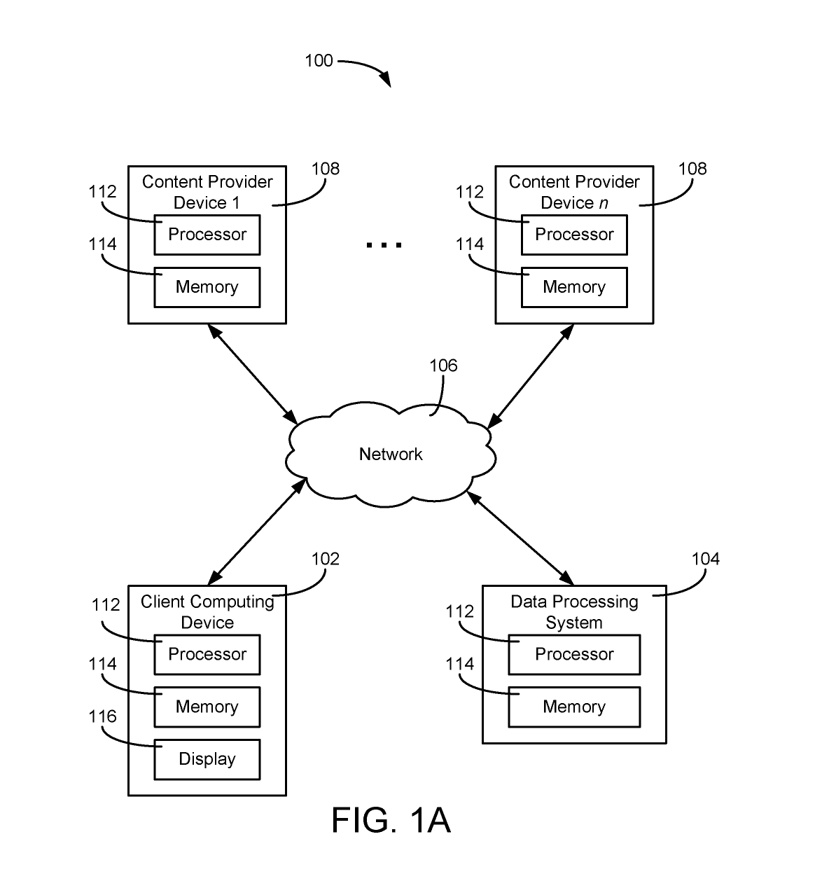

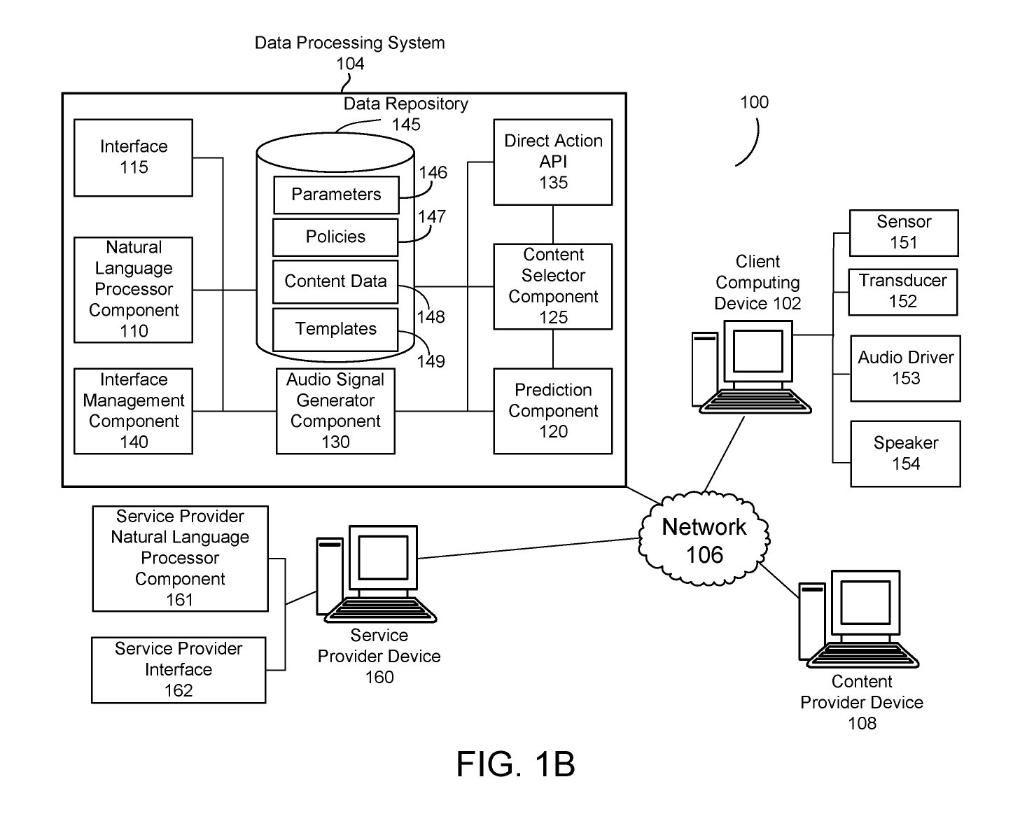

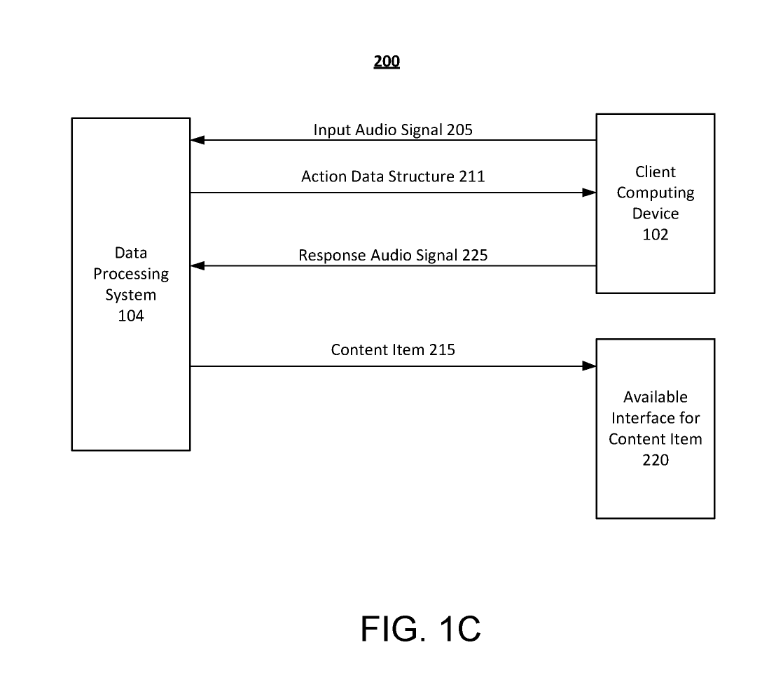

FIG. 1A is a block diagram of a computer system 100 in accordance with a described implementation. System 100 includes client computing device 102, which may communicate with other computing devices via a network 106. For example, client computing device 102 may communicate with one or more content sources ranging from a content provider computing device 108 up to an nth content source 110. Content provider computing devices 108 may provide webpages and/or media content (e.g., audio, video, and other forms of digital content) to client computing devices 102. System 100 may include a data processing system 104, which provides digital component data to other computing devices over network 106.

Network 106 may be any form of computer network that relays information between client computing device 102, data processing system 104, and content provider computing devices 108. For example, network 106 may include the Internet and/or other types of data networks, such as a local area network (LAN), a wide area network (WAN), a cellular network, satellite network, or other types of data networks. Network 106 may include any number of computing devices (e.g., computer, servers, routers, network switches, etc.) that are configured to receive and/or transmit data within network 106. Network 106 may include any number of hardwired and/or wireless connections. For example, client computing device 102 may communicate wirelessly (e.g., via WiFi, cellular, radio, etc.) with a transceiver that is hardwired (e.g., via a fiber optic cable, a CAT5 cable, etc.) to other computing devices in network 106.

Client computing device 102 may be any number of different user electronic devices configured to communicate via network 106 (e.g., a laptop computer, a desktop computer, a tablet computer, a smartphone, a digital video recorder, a set-top box for a television, a video game console, etc.). Client computing device 102 is shown to include a processor 112 and a memory 114, e.g., a processing circuit. Memory 114 stores machine instructions that, when executed by processor 112, cause processor 112 to perform one or more of the operations described herein. Processor 112 may include a microprocessor, application-specific integrated circuit (ASIC), field-programmable gate array (FPGA), etc., or combinations thereof. Memory 114 may include, but is not limited to, electronic, optical, magnetic, or any other storage or transmission device capable of providing processor 112 with program instructions. Memory 114 may include a floppy disk, CD-ROM, DVD, magnetic disk, memory chip, ASIC, FPGA, read-only memory (ROM), random-access memory (RAM), electrically-erasable ROM (EEPROM), erasable-programmable ROM (EPROM), flash memory, optical media, or any other suitable memory from which processor 112 can read instructions. The instructions may include code from any suitable computer-programming language such as, but not limited to, C, C++, C#, Java, JavaScript, Perl, Python and Visual Basic.

Client computing device 102 may include one or more user interface devices. In general, a user interface device refers to any electronic device that conveys data to a user by generating sensory information (e.g., a visualization on a display, one or more sounds, etc.) and/or converts received sensory information from a user into electronic signals (e.g., a keyboard, a mouse, a pointing device, a touch screen display, a microphone, etc.). The one or more user interface devices may be internal to a housing of client computing device 102 (e.g., a built-in display, microphone, etc.) or external to the housing of client computing device 102 (e.g., a monitor connected to client computing device 102, a speaker connected to client computing device 102, etc.), according to various implementations. For example, client computing device 102 may include an electronic display 116, which visually displays webpages using webpage data received from content provider computing devices 108 and/or from data processing system 104.

Content provider computing devices 108 are electronic devices connected to network 106 and provide media content to client computing device 102. For example, content provider computing devices 108 may be computer servers (e.g., FTP servers, file sharing servers, web servers, etc.) or other devices that include a processing circuit. Media content may include, but is not limited to, webpage data, a movie, a sound file, pictures, and other forms of data. Similarly, data processing system 104 may include a processing circuit including a processor 112 and a memory 114. In some implementations, data processing system 104 may include several computing devices (e.g., a data center, a network of servers, etc.). In such a case, the various devices of data processing system 104 may comprise a processing circuit (e.g., processor 112 represents the collective processors of the devices and memory 114 represents the collective memories of the devices).

Data processing system 104 may provide digital components to client computing device 102 via network 106. For example, content provider computing device 108 may provide a webpage to client computing device 102, in response to receiving a request for a webpage from client computing device 102. In some implementations, a digital component from data processing system 104 may be provided to client computing device 102 indirectly. For example, content provider computing device 108 may receive digital component data from data processing system 104 and use the digital component as part of the webpage data provided to client computing device 102. In other implementations, a digital component from data processing system 104 may be provided to client computing device 102 directly. For example, content provider computing device 108 may provide webpage data to client computing devices 102 that includes a command to retrieve a digital component from data processing system 104. On receipt of the webpage data, client computing device 102 may retrieve a digital component from data processing system 104 based on the command and display the digital component when the webpage is rendered on display 116.

According to various implementations, a user of client computing device 102 may search for, access, etc. various documents (e.g., web pages, web sites, articles, images, video, etc.) using a search engine via network 106. The web pages may be displayed as a search result from a search engine query containing search terms or keywords. Search engine queries may allow the user to enter a search term or keyword into the search engine to execute a document search. Search engines may be stored in memory 114 of data processing system 104 and may be accessible with client computing device 102. The result of an executed website search on a search engine may include a display on a search engine document of links to websites. Executed search engine queries may result in the display of digital component data generated and transmitted from data processing system 104. In some cases, search engines contract with service providers to display digital component to users of the search engine in response to certain search engine queries.

In other implementations, digital component may be displayed in a publication (e.g., a third-party web page) as in a display network. For example, a number of web pages and applications may show relevant digital components. The digital components may be matched to the web pages and other placements, such as mobile computing applications, according to relevant content or themes of the web pages. Specific web pages about specific topics may display the digital component. The digital component may be shown to all the web pages or a select number of web pages.

In another implementation, service providers may purchase or bid on the search terms such as keyword entries entered by users into a document such as a search engine. When the search term or keyword are entered into the document, then digital component data such as links to a service provider website may be displayed to the user. In some implementations, data processing system 104 may use an auction model that generates a digital component. Service Providers may bid on keywords using the auction model. The auction model may also be adjusted to reflect the maximum amount a service provider is willing to spend so that a user is exposed to a digital component a minimum number of times.

FIG. 1B depicts an example system 100 to for multi-modal transmission of packetized data in a voice activated data packet (or other protocol) based computer network environment. The system 100 can include at least one data processing system 104. The data processing system 104 can include at least one server having at least one processor. For example, the data processing system 104 can include a plurality of servers located in at least one data center or server farm. The data processing system 104 can determine, from an audio input signal a request and a trigger keyword associated with the request. Based on the request and trigger keyword the data processing system 104 can determine or select at least one action data structure, and can select at least one content item (and initiate other actions as described herein). The data processing system 104 can identify candidate interfaces for rendering of the action data structures or the content items, and can provide the action data structures or the content items for rendering by one or more candidate interfaces on one or more client computing devices based on resource utilization values for or of the candidate interfaces, for example, as part of a voice activated communication or planning system. The action data structures (or the content items) can include one or more audio files that when rendered provide an audio output or acoustic wave. The action data structures or the content items can include other content (e.g., text, video, or image content) in addition to audio content.

The data processing system 104 can include multiple, logically-grouped servers and facilitate distributed computing techniques. The logical group of servers may be referred to as a data center, server farm or a machine farm. The servers can be geographically dispersed. A data center or machine farm may be administered as a single entity, or the machine farm can include a plurality of machine farms. The servers within each machine farm can be heterogeneous—one or more of the servers or machines can operate according to one or more type of operating system platform. The data processing system 104 can include servers in a data center that are stored in one or more high-density rack systems, along with associated storage systems, located for example, in an enterprise data center. The data processing system 104 with consolidated servers in this way can improve system manageability, data security, the physical security of the system, and system performance by locating servers and high-performance storage systems on localized high-performance networks. Centralization of all or some of the data processing system 104 components, including servers and storage systems, and coupling them with advanced system management tools allows more efficient use of server resources, which saves power and processing requirements and reduces bandwidth usage.

The data processing system 104 can include at least one natural language processor (NLP) component 110, at least one interface 115, at least one prediction component 120, at least one content selector component 125, at least one audio signal generator component 130, at least one direct action application programming interface (API) 135, at least one interface management component 140, and at least one data repository 145. The NLP component 110, interface 115, prediction component 120, content selector component 125, audio signal generator component 130, direct action API 135, and interface management component 140 can each include at least one processing unit, server, virtual server, circuit, engine, agent, appliance, or other logic device such as programmable logic arrays configured to communicate with the data repository 145 and with other computing devices (e.g., at least one client computing device 102, at least one content provider computing device 108, or at least one service provider computing device 160) via the at least one computer network 106. The network 106 can include computer networks such as the internet, local, wide, metro or other area networks, intranets, satellite networks, other computer networks such as voice or data mobile phone communication networks, and combinations thereof.

The network 106 can include or constitute a display network, e.g., a subset of information resources available on the internet that are associated with a content placement or search engine results system, or that are eligible to include third party content items as part of a content item placement campaign. The network 106 can be used by the data processing system 104 to access information resources such as web pages, web sites, domain names, or uniform resource locators that can be presented, output, rendered, or displayed by the client computing device 102. For example, via the network 106 a user of the client computing device 102 can access information or data provided by the data processing system 104, the content provider computing device 108 or the service provider computing device 160.

The network 106 can include, For example, a point-to-point network, a broadcast network, a wide area network, a local area network, a telecommunications network, a data communication network, a computer network, an ATM (Asynchronous Transfer Mode) network, a SONET (Synchronous Optical Network) network, a SDH (Synchronous Digital Hierarchy) network, a wireless network or a wireline network, and combinations thereof. The network 106 can include a wireless link, such as an infrared channel or satellite band. The topology of the network 106 may include a bus, star, or ring network topology. The network 106 can include mobile telephone networks using any protocol or protocols used to communicate among mobile devices, including advanced mobile phone protocol (“AMPS”), time division multiple access (“TDMA”), code-division multiple access (“CDMA”), global system for mobile communication (“GSM”), general packet radio services (“GPRS”) or universal mobile telecommunications system (“UMTS”). Different types of data may be transmitted via different protocols, or the same types of data may be transmitted via different protocols.

The client computing device 102, the content provider computing device 108, and the service provider computing device 160 can each include at least one logic device such as a computing device having a processor to communicate with each other or with the data processing system 104 via the network 106. The client computing device 102, the content provider computing device 108, and the service provider computing device 160 can each include at least one server, processor or memory, or a plurality of computation resources or servers located in at least one data center. The client computing device 102, the content provider computing device 108, and the service provider computing device 160 can each include at least one computing device such as a desktop computer, laptop, tablet, personal digital assistant, smartphone, portable computer, server, thin client computer, virtual server, or other computing device.

The client computing device 102 can include at least one sensor 151, at least one transducer 152, at least one audio driver 153, and at least one speaker 154. The sensor 151 can include a microphone or audio input sensor. The transducer 152 can convert the audio input into an electronic signal, or vice-versa. The audio driver 153 can include a script or program executed by one or more processors of the client computing device 102 to control the sensor 151, the transducer 152 or the audio driver 153, among other components of the client computing device 102 to process audio input or provide audio output. The speaker 154 can transmit the audio output signal.

The client computing device 102 can be associated with an end user that enters voice queries as audio input into the client computing device 102 (via the sensor 151) and receives audio output in the form of a computer generated voice that can be provided from the data processing system 104 (or the content provider computing device 108 or the service provider computing device 160) to the client computing device 102, output from the speaker 154. The audio output can correspond to an action data structure received from the direct action API 135, or a content item selected by the content selector component 125. The computer generated voice can include recordings from a real person or computer generated language.

The content provider computing device 108 (or the data processing system 104 or service provider computing device 160) can provide audio based content items or action data structures for display by the client computing device 102 as an audio output. The action data structure or content item can include an organic response or offer for a good or service, such as a voice based message that states: “Today it will be sunny and 80 degrees at the beach” as an organic response to a voice-input query of “Is today a beach day?”. The data processing system 104 (or other system 100 component such as the content provider computing device 108 can also provide a content item as a response, such as a voice or text message based content item offering sunscreen.

The content provider computing device 108 or the data repository 145 can include memory to store a series of audio action data structures or content items that can be provided in response to a voice based query. The action data structures and content items can include packet based data structures for transmission via the network 106. The content provider computing device 108 can also provide audio or text based content items (or other content items) to the data processing system 104 where they can be stored in the data repository 145. The data processing system 104 can select the audio action data structures or text based content items and provide (or instruct the content provider computing device 108 to provide) them to the same or different client computing devices 102 responsive to a query received from one of those client computing devices 102. The audio based action data structures can be exclusively audio or can be combined with text, image, or video data. The content items can be exclusively text or can be combined with audio, image or video data.

The service provider computing device 160 can include at least one service provider natural language processor (NLP) component 161 and at least one service provider interface 162. The service provider NLP component 161 (or other components such as a direct action API of the service provider computing device 160) can engage with the client computing device 102 (via the data processing system 104 or bypassing the data processing system 104) to create a back-and-forth real-time voice or audio based conversation (e.g., a session) between the client computing device 102 and the service provider computing device 160. For example, the service provider interface 162 can receive or provide data messages (e.g., action data structures or content items) to the direct action API 135 of the data processing system 104. The direct action API 135 can also generate the action data structures independent from or without input from the service provider computing device 160. The service provider computing device 160 and the content provider computing device 108 can be associated with the same entity. For example, the content provider computing device 108 can create, store, or make available content items for beach relates services, such as sunscreen, beach towels or bathing suits, and the service provider computing device 160 can establish a session with the client computing device 102 to respond to a voice input query about the weather at the beach, directions for a beach, or a recommendation for an area beach, and can provide these content items to the end user of the client computing device 102 via an interface of the same client computing device 102 from which the query was received, a different interface of the same client computing device 102, or an interface of a different client computing device. The data processing system 104, via the direct action API 135, the NLP component 110 or other components can also establish the session with the client computing device, including or bypassing the service provider computing device 160, to for example, to provide an organic response to a query related to the beach.

The data repository 145 can include one or more local or distributed databases, and can include a database management system. The data repository 145 can include computer data storage or memory and can store one or more parameters 146, one or more policies 147, content data 148, or templates 149 among other data. The parameters 146, policies 147, and templates 149 can include information such as rules about a voice based session between the client computing device 102 and the data processing system 104 (or the service provider computing device 160). The content data 148 can include content items for audio output or associated metadata, as well as input audio messages that can be part of one or more communication sessions with the client computing device 102.

The system 100 can optimize processing of action data structures and content items in a voice activated data packet (or other protocol) environment. For example, the data processing system 104 can include or be part of a voice activated assistant service, voice command device, intelligent personal assistant, knowledge navigator, event planning, or another assistant program. The data processing system 104 can provide one or more instances of action data structures as audio output for display from the client computing device 102 to accomplish tasks related to an input audio signal. For example, the data processing system can communicate with the service provider computing device 160 or other third party computing devices to generate action data structures with information about a beach, among other things. For example, an end user can enter an input audio signal into the client computing device 102 of: “OK, I would like to go to the beach this weekend” and an action data structure can indicate the weekend weather forecast for area beaches, such as “it will be sunny and 80 degrees at the beach on Saturday, with high tide at 3 pm.”

The action data structures can include a number of organic or non-sponsored responses to the input audio signal. For example, the action data structures can include a beach weather forecast or directions to a beach. The action data structures in this example include organic or non-sponsored content that is directly responsive to the input audio signal. The content items responsive to the input audio signal can include sponsored or non-organic content, such as an offer to buy sunscreen from a convenience store located near the beach. In this example, the organic action data structure (beach forecast) is responsive to the input audio signal (a query related to the beach), and the content item (a reminder or offer for sunscreen) is also responsive to the same input audio signal. The data processing system 104 can evaluate system 100 parameters (e.g., power usage, available displays, formats of displays, memory requirements, bandwidth usage, power capacity or time of input power (e.g., internal battery or external power source such as a power source from a wall output) to provide the action data structure and the content item to different candidate interfaces on the same client computing device 102, or to different candidate interfaces on different client computing devices 102.

The data processing system 104 can include an application, script or program installed at the client computing device 102, such as an app to communicate input audio signals (e.g., as data packets via a packetized or other protocol based transmission) to at least one interface 115 of the data processing system 104 and to drive components of the client computing device 102 to render output audio signals (e.g., for action data structures) or other output signals (e.g., content items). The data processing system 104 can receive data packets or other signal that includes or identifies an audio input signal. For example, the data processing system 104 can execute or run the NLP component 110 to receive the audio input signal.

The NLP component 110 can convert the audio input signal into recognized text by comparing the input signal against a stored, representative set of audio waveforms (e.g., in the data repository 145) and choosing the closest matches. The representative waveforms are generated across a large set of users, and can be augmented with speech samples. After the audio signal is converted into recognized text, the NLP component 110 can match the text to words that are associated, for example, via training across users or through manual specification, with actions that the data processing system 104 can serve.

The audio input signal can be detected by the sensor 151 (e.g., a microphone) of the client computing device. Via the transducer 152, the audio driver 153, or other components the client computing device 102 can provide the audio input signal to the data processing system 104 (e.g., via the network 106) where it can be received (e.g., by the interface 115) and provided to the NLP component 110 or stored in the data repository 145 as content data 148.

The NLP component 110 can receive or otherwise obtain the input audio signal. From the input audio signal, the NLP component 110 can identify at least one request or at least one trigger keyword corresponding to the request. The request can indicate intent or subject matter of the input audio signal. The trigger keyword can indicate a type of action likely to be taken. For example, the NLP component 110 can parse the input audio signal to identify at least one request to go to the beach for the weekend. The trigger keyword can include at least one word, phrase, root or partial word, or derivative indicating an action to be taken. For example, the trigger keyword “go” or “to go to” from the input audio signal can indicate a need for transport or a trip away from home. In this example, the input audio signal (or the identified request) does not directly express an intent for transport, however the trigger keyword indicates that transport is an ancillary action to at least one other action that is indicated by the request.

The prediction component 120 (or other mechanism of the data processing system 104) can generate, based on the request or the trigger keyword, at least one action data structure associated with the input audio signal. The action data structure can indicate information related to subject matter of the input audio signal. The action data structure can include one or more than one action, such as organic responses to the input audio signal. For example, the input audio signal “OK, I would like to go to the beach this weekend” can include at least one request indicating an interest for a beach weather forecast, surf report, or water temperature information, and at least one trigger keyword, e.g., “go” indicating travel to the beach, such as a need for items one may want to bring to the beach, or a need for transportation to the beach. The prediction component 120 can generate or identify subject matter for at least one action data structure, an indication of a request for a beach weather forecast, as well as subject matter for a content item, such as an indication of a query for sponsored content related to spending a day at a beach. From the request or the trigger keyword the prediction component 120 (or other system 100 component such as the NLP component 110 or the direct action API 135) predicts, estimates, or otherwise determines subject matter for action data structures or for content items. From this subject matter, the direct action API 135 can generate at least one action data structure and can communicate with at least one content provider computing device 108 to obtain at least one content item 110. The prediction component 120 can access the parameters 146 or policies 147 in the data repository 145 to determine or otherwise estimate requests for action data structures or content items. For example, the parameters 146 or policies 147 could indicate requests for a beach weekend weather forecast action or for content items related to beach visits, such as a content item for sunscreen.

The content selector component 125 can obtain indications of any of the interest in or request for the action data structure or for the content item. For example, the prediction component 120 can directly or indirectly (e.g., via the data repository 145) provide an indication of the action data structure or content item to the content selector component 125. The content selector component 125 can obtain this information from the data repository 145, where it can be stored as part of the content data 148. The indication of the action data structure can inform the content selector component 125 of a need for area beach information, such as a weather forecast or products or services the end user may need for a trip to the beach.

From the information received by the content selector component 125, e.g., an indication of a forthcoming trip to the beach, the content selector component 125 can identify at least one content item. The content item can be responsive or related to the subject matter of the input audio query. For example, the content item can include data message identifying as tore near the beach that has sunscreen, or offering a taxi ride to the beach. The content selector component 125 can query the data repository 145 to select or otherwise identify the content item, e.g., from the content data 148. The content selector component 125 can also select the content item from the content provider computing device 108. For example, responsive to a query received from the data processing system 104, the content provider computing device 108 can provide a content item to the data processing system 104 (or component thereof) for eventual output by the client computing device 102 that originated the input audio signal, or for output to the same end user by a different client computing device 102.

The audio signal generator component 130 can generate or otherwise obtain an output signal that includes the content item (as well as the action data structure) responsive to the input audio signal. For example, the data processing system 104 can execute the audio signal generator component 130 to generate or create an output signal corresponding to the action data structure or to the content item. The interface component 115 of the data processing system 104 can provide or transmit one or more data packets that include the output signal via the computer network 106 to any client computing device 102. The interface 115 can be designed, configured, constructed, or operational to receive and transmit information using, for example, data packets. The interface 115 can receive and transmit information using one or more protocols, such as a network protocol. The interface 115 can include a hardware interface, software interface, wired interface, or wireless interface. The interface 115 can facilitate translating or formatting data from one format to another format. For example, the interface 115 can include an application programming interface that includes definitions for communicating between various components, such as software components of the system 100.

The data processing system 104 can provide the output signal including the action data structure from the data repository 145 or from the audio signal generator component 130 to the client computing device 102. The data processing system 104 can provide the output signal including the content item from the data repository 145 or from the audio signal generator component 130 to the same or to a different client computing device 102.

The data processing system 104 can also instruct, via data packet transmissions, the content provider computing device 108 or the service provider computing device 160 to provide the output signal (e.g., corresponding to the action data structure or to the content item) to the client computing device 102. The output signal can be obtained, generated, transformed to or transmitted as one or more data packets (or other communications protocol) from the data processing system 104 (or other computing device) to the client computing device 102.

The content selector component 125 can select the content item or the action data structure for the as part of a real-time content selection process. For example, the action data structure can be provided to the client computing device 102 for transmission as audio output by an interface of the client computing device 102 in a conversational manner in direct response to the input audio signal. The real-time content selection process to identify the action data structure and provide the content item to the client computing device 102 can occur within one minute or less from the time of the input audio signal and be considered real-time. The data processing system 104 can also identify and provide the content item to at least one interface of the client computing device 102 that originated the input audio signal, or to a different client computing device 102.

The action data structure (or the content item), For example, obtained or generated by the audio signal generator component 130 transmitted via the interface 115 and the computer network 106 to the client computing device 102, can cause the client computing device 102 to execute the audio driver 153 to drive the speaker 154 to generate an acoustic wave corresponding to the action data structure or to the content item. The acoustic wave can include words of or corresponding to the action data structure or content item.

The acoustic wave representing the action data structure can be output from the client computing device 102 separately from the content item. For example, the acoustic wave can include the audio output of “Today it will be sunny and 80 degrees at the beach.” In this example, the data processing system 104 obtains the input audio signal of, for example, “OK, I would like to go to the beach this weekend.” From this information, the NLP component 110 identifies at least one request or at least one trigger keyword, and the prediction component 120 uses the request(s) or trigger keyword(s) to identify a request for an action data structure or for a content item. The content selector component 125 (or other component) can identify, select, or generate a content item for, e.g., sunscreen available near the beach. The direct action API 135 (or other component) can identify, select, or generate an action data structure for, e.g., the weekend beach forecast. The data processing system 104 or component thereof such as the audio signal generator component 130 can provide the action data structure for output by an interface of the client computing device 102. For example, the acoustic wave corresponding to the action data structure can be output from the client computing device 102. The data processing system 104 can provide the content item for output by a different interface of the same client computing device 102 or by an interface of a different client computing device 102.

The packet based data transmission of the action data structure by data processing system 104 to the client computing device 102 can include a direct or real-time response to the input audio signal of “OK, I would like to go to the beach this weekend” so that the packet based data transmissions via the computer network 106 that are part of a communication session between the data processing system 104 and the client computing device 102 with the flow and feel of a real-time person to person conversation. This packet based data transmission communication session can also include the content provider computing device 108 or the service provider computing device 160.

The content selector component 125 can select the content item or action data structure based on at least one request or at least one trigger keyword of the input audio signal. For example, the requests of the input audio signal “OK, I would like to go to the beach this weekend” can indicate subject matter of the beach, travel to the beach, or items to facilitate a trip to the beach. The NLP component 110 or the prediction component 120 (or other data processing system 104 components executing as part of the direct action API 135) can identify the trigger keyword “go” “go to” or “to go to” and can determine a transportation request to the beach based at least in part on the trigger keyword. The NLP component 110 (or other system 100 component) can also determine a solicitation for content items related to beach activity, such as for sunscreen or beach umbrellas. Thus, the data processing system 104 can infer actions from the input audio signal that are secondary requests (e.g., a request for sunscreen) that are not the primary request or subject of the input audio signal (information about the beach this weekend).

The action data structures and content items can correspond to subject matter of the input audio signal. The direct action API 135 can execute programs or scripts, for example, from the NLP component 110, the prediction component 120, or the content selector component 125 to identify action data structures or content items for one or more of these actions. The direct action API 135 can execute a specified action to satisfy the end user's intention, as determined by the data processing system 104. Depending on the action specified in its inputs, the direct action API 135 can execute code or a dialog script that identifies the parameters required to fulfill a user request. Such code can lookup additional information, e.g., in the data repository 145, such as the name of a home automation service, or it can provide audio output for rendering at the client computing device 102 to ask the end user questions such as the intended destination of a requested taxi. The direct action API 135 can determine necessary parameters and can package the information into an action data structure, which can then be sent to another component such as the content selector component 125 or to the service provider computing device 160 to be fulfilled.

The direct action API 135 of the data processing system 104 can generate, based on the request or the trigger keyword, the action data structures. The action data structures can be generated responsive to the subject matter of the input audio signal. The action data structures can be included in the messages that are transmitted to or received by the service provider computing device 160. Based on the audio input signal parsed by the NLP component 110, the direct action API 135 can determine to which, if any, of a plurality of service provider computing devices 160 the message should be sent. For example, if an input audio signal includes “OK, I would like to go to the beach this weekend,” the NLP component 110 can parse the input audio signal to identify requests or trigger keywords such as the trigger keyword word “to go to” as an indication of a need for a taxi. The direct action API 135 can package the request into an action data structure for transmission as a message to a service provider computing device 160 of a taxi service. The message can also be passed to the content selector component 125. The action data structure can include information for completing the request. In this example, the information can include a pick up location (e.g., home) and a destination location (e.g., a beach). The direct action API 135 can retrieve a template 149 from the data repository 145 to determine which fields to include in the action data structure. The direct action API 135 can retrieve content from the data repository 145 to obtain information for the fields of the data structure. The direct action API 135 can populate the fields from the template with that information to generate the data structure. The direct action API 135 can also populate the fields with data from the input audio signal. The templates 149 can be standardized for categories of service providers or can be standardized for specific service providers. For example, ride sharing service providers can use the following standardized template 149 to create the data structure: {client_{deviceidentifier}; authentication_{credentials}; pick_{uplocation}; destination_{location}; no_{passengers}; serviceₗₑᵥₑₗ}.

The content selector component 125 can identify, select, or obtain multiple content items resulting from a multiple content selection processes. The content selection processes can be real-time, e.g., part of the same conversation, communication session, or series of communications sessions between the data processing system 104 and the client computing device 102 that involve common subject matter. The conversation can include asynchronous communications separated from one another by a period of hours or days, for example. The conversation or communication session can last for a time period from receipt of the first input audio signal until an estimated or known conclusion of a final action related to the first input audio signal, or receipt by the data processing system 104 of an indication of a termination or expiration of the conversation. For example, the data processing system 104 can determine that a conversation related to a weekend beach trip begins at the time or receipt of the input audio signal and expires or terminates at the end of the weekend, e.g., Sunday night or Monday morning. The data processing system 104 that provides action data structures or content items for rendering by one or more interfaces of the client computing device 102 or of another client computing device 102 during the active time period of the conversation (e.g., from receipt of the input audio signal until a determined expiration time) can be considered to be operating in real-time. In this example, the content selection processes and rendering of the content items and action data structures occurs in real time.

The interface management component 140 can poll, determine, identify, or select interfaces for rendering of the action data structures and of the content items related to the input audio signal. For example, the interface management component 140 can identify one or more candidate interfaces of client computing devices 102 associated with an end user that entered the input audio signal (e.g., “What is the weather at the beach today?”) into one of the client computing devices 102 via an audio interface. The interfaces can include hardware such as sensor 151 (e.g., a microphone), speaker 154, or a screen size of a computing device, alone or combined with scripts or programs (e.g., the audio driver 153) as well as apps, computer programs, online documents (e.g., webpage) interfaces and combinations thereof.

The interfaces can include social media accounts, text message applications, or email accounts associated with an end user of the client computing device 102 that originated the input audio signal. Interfaces can include the audio output of a smartphone, or an app based messaging device installed on the smartphone, or on a wearable computing device, among other client computing devices 102. The interfaces can also include display screen parameters (e.g., size, resolution), audio parameters, mobile device parameters, (e.g., processing power, battery life, existence of installed apps or programs, or sensor 151 or speaker 154 capabilities), content slots on online documents for text, image, or video renderings of content items, chat applications, laptops parameters, smartwatch or other wearable device parameters (e.g., indications of their display or processing capabilities), or virtual reality headset parameters.

The interface management component 140 can poll a plurality of interfaces to identify candidate interfaces. Candidate interfaces include interfaces having the capability to render a response to the input audio signal, (e.g., the action data structure as an audio output, or the content item that can be output in various formats including non-audio formats). The interface management component 140 can determine parameters or other capabilities of interfaces to determine that they are (or are not) candidate interfaces. For example, the interface management component 140 can determine, based on parameters 146 of the content item or of a first client computing device 102 (e.g., a smartwatch wearable device), that the smartwatch includes an available visual interface of sufficient size or resolution to render the content item. The interface management component 140 can also determine that the client computing device 102 that originated the input audio signal has a speaker 154 hardware and installed program e.g., an audio driver or other script to render the action data structure.

The interface management component 140 can determine utilization values for candidate interfaces. The utilization values can indicate that a candidate interface can (or cannot) render the action data structures or the content items provided in response to input audio signals. The utilization values can include parameters 146 obtained from the data repository 145 or other parameters obtained from the client computing device 102, such as bandwidth or processing utilizations or requirements, processing power, power requirements, battery status, memory utilization or capabilities, or other interface parameters that indicate the available of an interface to render action data structures or content items. The battery status can indicate a type of power source (e.g., internal battery or external power source such as via an output), a charging status (e.g., currently charging or not), or an amount of remaining battery power. The interface management component 140 can select interfaces based on the battery status or charging status.

The interface management component 140 can order the candidate interfaces in a hierarchy or ranking based on the utilization values. For example, different utilization values (e.g., processing requirements, display screen size, accessibility to the end user) can be given different weights. The interface management component 140 can rank one or more of the utilization values of the candidate interfaces based on their weights to determine an optimal corresponding candidate interface for rendering of the content item (or action data structure). Based on this hierarchy, the interface management component 140 can select the highest ranked interface for rendering of the content item.

Based on utilization values for candidate interfaces, the interface management component 140 can select at least one candidate interface as a selected interface for the content item. The selected interface for the content item can be the same interface from which the input audio signal was received (e.g., an audio interface of the client computing device 102) or a different interface (e.g., a text message based app of the same client computing device 102, or an email account accessible from the same client computing device 102.

The interface management component 140 can select an interface for the content item that is an interface of a different client computing device 102 than the device that originated the input audio signal. For example, the data processing system 104 can receive the input audio signal from a first client computing device 102 (e.g., a smartphone), and can select an interface such as a display of a smartwatch (or any other client computing device for rendering of the content item. The multiple client computing devices 102 can all be associated with the same end user. The data processing system 104 can determine that multiple client computing devices 102 are associated with the same end user based on information received with consent from the end user such as user access to a common social media or email account across multiple client computing devices 102.

The interface management component 140 can also determine that an interface is unavailable. For example, the interface management component 140 can poll interfaces and determine that a battery status of a client computing device 102 associated with the interface is low, or below a threshold level such as 10%. Or the interface management component 140 can determine that the client computing device 102 associated with the interface lacks sufficient display screen size or processing power to render the content item, or that the processor utilization rate is too high, as the client computing device is currently executing another application, For example, to stream content via the network 106. In these and other examples the interface management component 140 can determine that the interface is unavailable and can eliminate the interface as a candidate for rendering the content item or the action data structure.

Thus, the interface management component 140 can determine that a candidate interface accessible by the first client computing device 102 is linked to an account of an end user, and that a second candidate interface accessible by a second client computing device 102 is also linked to the same account. For example, both client computing devices 102 may have access to the same social media account, e.g., via installation of an app or script at each client computing device 102. The interface management component 140 can also determine that multiple interfaces correspond to the same account, and can provide multiple, different content items to the multiple interfaces corresponding to the common account. For example, the data processing system 104 can determine, with end user consent, that an end user has accessed an account from different client computing devices 102. These multiple interfaces can be separate instances of the same interface (e.g., the same app installed on different client computing devices 102) or different interfaces such as different apps for different social media accounts that are both linked to a common email address account, accessible from multiple client computing devices 102.

The interface management component 140 can also determine or estimate distances between client computing devices 102 associated with candidate interfaces. For example, the data processing system 104 can obtain, with user consent, an indication that the input audio signal originated from a smartphone or virtual reality headset computing device 102, and that the end user is associated with an active smartwatch client computing device 102. From this information, the interface management component can determine that the smartwatch is active, e.g., being worn by the end user when the end user enters the input audio signal into the smartphone, so that the two client computing devices 102 are within a threshold distance of one another. In another example, the data processing system 104 can determine, with end user consent, the location of a smartphone that is the source of an input audio signal, and can also determine that a laptop account associated with the end user is currently active. For example, the laptop can be signed into a social media account indicating that the user is currently active on the laptop. In this example, the data processing system 104 can determine that the end user is within a threshold distance of the smartphone and of the laptop, so that the laptop can be an appropriate choice for rendering of the content item via a candidate interface.

The interface management component 140 can select the interface for the content item based on at least one utilization value indicating that the selected interface is the most efficient for the content item. For example, from among candidate interfaces, the interface to render the content item at the smartwatch uses the least bandwidth due as the content item is smaller and can be transmitted with fewer resources. Or the interface management component 140 can determine that the candidate interface selected for rendering of the content item is currently charging (e.g., plugged in) so that rendering of the content item by the interface will not drain battery power of the corresponding client computing device 102. In another example, the interface management component 140 can select a candidate interface that is currently performing fewer processing operations than another, unselected interface of for example, a different client computing device 102 that is currently streaming video content from the network 106 and therefore less available to render the content item without delay.

The interface management component 140 (or other data processing system 104 component) can convert the content item for delivery in a modality compatible with the candidate interface. For example, if the candidate interface is a display of a smartwatch, smartphone, or tablet computing device, the interface management component 140 can size the content item for appropriate visual display given the dimensions of the display screen associated with the interface. The interface management component 140 can also convert the content item to a packet or other protocol based format, including proprietary or industry standard format for transmission to the client computing device 102 associated with the selected interface. The interface selected by the interface management component 140 for the content item can include an interface accessible from multiple client computing devices 102 by the end user. For example, the interface can be or include a social media account that the end user can access via the client computing device 102 that originated the input audio signal (e.g., a smartphone) as well as other client computing devices such as tabled or desktop computers or other mobile computing devices.

The interface management component 140 can also select at least one candidate interface for the action data structure. This interface can be the same interface from which the input audio signal was obtained, e.g., a voice activated assistant service executed at a client computing device 102. This can be the same interface or a different interface than the interface management component 140 selects for the content item. The interface management component 140 (or other data processing system 104 components) can provide the action data structure to the same client computing device 102 that originated the input audio signal for rendering as audio output as part of the assistant service. The interface management component 140 can also transmit or otherwise provide the content item to the selected interface for the content item, in any converted modality appropriate for rendering by the selected interface.

Thus, the interface management component 140 can provide the action data structure as audio output for rendering by an interface of the client computing device 102 responsive to the input audio signal received by the same client computing device 102. The interface management component 140 can also provide the content item for rendering by a different interface of the same client computing device 102 or of a different client computing device 102 associated with the same end user. For example, the action data structure, e.g., “it will be sunny and 80 degrees at the beach on Saturday” can be provided for audio rendering by the client computing device as part of an assistant program interface executing in part at the client computing device 102, and the content item e.g., a text, audio, or combination content item indicating that “sunscreen is available from the convenience store near the beach” can be provided for rendering by an interface of the same or a different computing device 102, such as an email or text message accessible by the same or a different client computing device 102 associated with the end user.

Separating the content item from the action data structure and sending the content item as, for example, a text message rather than an audio message can result in reduced processing power for the client computing device 102 that accesses the content item since, for example, text message data transmissions are less computationally intensive than audio message data transmissions. This separation can also reduce power usage, memory storage, or transmission bandwidth used to render the content item. This results in increased processing, power, and bandwidth efficiencies of the system 100 and devices such as the client computing devices 102 and the data processing system 104. This increases the efficiency of the computing devices that process these transactions, and increases the speed with which the content items can be rendered. The data processing system 104 can process thousands, tens of thousands or more input audio signals simultaneously so the bandwidth, power, and processing savings can be significant and not merely incremental or incidental.

The interface management component 140 can provide or deliver the content item to the same client computing device 102 (or a different device) as the action data structure subsequent to delivery of the action data structure to the client computing device 102. For example, the content item can be provided for rendering via the selected interface upon conclusion of audio output rendering of the action data structure. The interface management component 140 can also provide the content item to the selected interface concurrent with the provision of the action data structure to the client computing device 102. The interface management component 140 can provide the content item for delivery via the selected interface within a pre-determined time period from receipt of the input audio signal by the NLP component 110. The time period, for example, can be any time during an active length of the conversation of session. For example, if the input audio signal is “I would like to go to the beach this weekend” the pre-determined time period can be any time from receipt of the input audio signal through the end of the weekend, e.g., the active period of the conversation. The pre-determined time period can also be a time triggered from rendering of the action data structure as audio output by the client computing device 102, such as within 5 minutes, one hour or one day of this rendering.

The interface management component 140 can provide the action data structure to the client computing device 102 with an indication of the existence of the content item. For example, the data processing system 104 can provide the action data structure that renders at the client computing device 102 to provide the audio output “it will be sunny and 80 degrees at the beach on Saturday, check your email for more information.” The phrase “check your email for more information” can indicate the existence of a content item, e.g., for sunscreen, provided by the data processing system 104 to an interface (e.g., email). In this example, sponsored content can be provided as content items to the email (or other) interface and organic content such as the weather can be provided as the action data structure for audio output.

The data processing system 104 can also provide the action data structure with a prompt that queries the user to determine user interest in obtaining the content item. For example, the action data structure can indicate “it will be sunny and 80 degrees at the beach on Saturday, would you like to hear about some services to assist with your trip?” The data processing system 104 can receive another audio input signal from the client computing device 102 in response to the prompt “would you like to hear about some services to assist with your trip?” such as “sure”. The NLP component 110 can parse this response, e.g., “sure” and interpret it as authorization for audio rendering of the content item by the client computing device 102. In response, the data processing system 104 can provide the content item for audio rendering by the same client computing device 102 from which the response “sure” originated.

The data processing system 104 can delay transmission of the content item associated with the action data structure to optimize processing utilization. For example, the data processing system 104 provide the action data structure for rendering as audio output by the client computing device in real-time responsive to receipt of the input audio signal, e.g., in a conversational manner, and can delay content item transmission until an off-peak or non-peak period of data center usage, which results in more efficient utilization of the data center by reducing peak bandwidth usage, heat output or cooling requirements. The data processing system 104 can also initiate a conversion or other activity associated with the content item, such as ordering a car service responsive to a response to the action data structure or to the content item, based on data center utilization rates or bandwidth metrics or requirements of the network 106 or of a data center that includes the data processing system 104.

Based on a response to a content item or to the action data structure for a subsequent action, such as a click on the content item rendered via the selected interface, the data processing system 104 can identify a conversion, or initiate a conversion or action. Processors of the data processing system 104 can invoke the direct action API 135 to execute scripts that facilitate the conversion action, such as to order a car from a car share service to take the end user to or from the beach. The direct action API 135 can obtain content data 148 (or parameters 146 or policies 147) from the data repository 145, as well as data received with end user consent from the client computing device 102 to determine location, time, user accounts, logistical or other information in order to reserve a car from the car share service. Using the direct action API 135, the data processing system 104 can also communicate with the service provider computing device 160 to complete the conversion by in this example making the car share pick up reservation.

FIG. 1C depicts a flow diagram 200 for multi-modal transmission of packetized data in a voice activated computer network environment. The data processing system 104 can receive the input audio signal 205, e.g., “OK, I would like to go to the beach this weekend.” In response, the data processing system generates at least one action data structure 211 and at least one content item 215. The action data structure 205 can include organic or non-sponsored content, such as a response for audio rendering stating “It will be sunny and 80 degrees at the beach this weekend” or “high tide is at 3 pm.” The data processing system 104 can provide the action data structure 211 to the same client computing device 102 that originated the input audio signal 205, for rendering by a candidate interface of the client computing device 102, e.g., as output in a real time or conversational manner as part of a digital or conversational assistant platform.

The data processing system 104 can select the candidate interface 220 as a selected interface for the content item 215, and can provide the content item 215 to the selected interface 220. The content item 215 can also include a data structure, converted to the appropriate modality by the data processing system 104 for rendering by the selected interface 220. The content item 215 can include sponsored content, such as an offer to rent a beach chair for the day, or for sunscreen. The selected interface 220 can be part of or executed by the same client computing device 102 or by a different device accessible by the end user of the client computing device 102. Transmission of the action data structure 211 and the content item 215 can occur at the same time or subsequent to one another. The action data structure 211 can include an indicator that the content item 215 is being or will be transmitted separately via a different modality or format to the selected interface 220, alerting the end user to the existence of the content item 215.

The action data structure 211 and the content item 215 can be provided separately for rendering to the end user. By separating the sponsored content (content item 215) from the organic response (action data structure 211) audio or other alerts indicating that the content item 215 is sponsored do not need to be provided with the action data structure 211. This can reduce bandwidth requirements associated with transmission of the action data structure 211 via the network 106 and can simplify rendering of the action data structure 211. For example, without audio disclaimer or warning messages.

The data processing system 104 can receive a response audio signal 225. The response audio signal 225 can include an audio signal such as, “great, please book me a hotel on the beach this weekend.” Receipt by the data processing system 104 of the response audio signal 225 can cause the data processing system to invoke the direct action API 135 to execute a conversion to, for example, book a hotel room on the beach. The direct action API 135 can also communicate with at least one service provider computing device 160 to provide information to the service provider computing device 160 so that the service provider computing device 160 can complete or confirm the booking process.

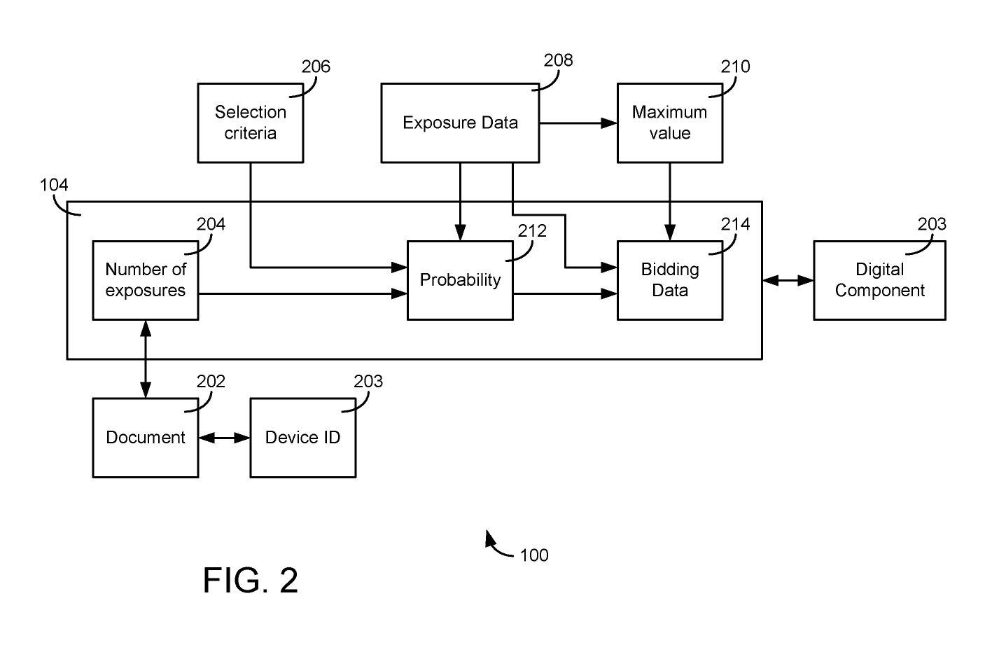

FIG. 2 is an example of an illustration of a block diagram of a system 100 for serving digital components for a minimum number of exposures in accordance with a described implementation.

In a brief overview, system 100 includes document 202, data processing system 104, and service provider module 206. Generally, system 100 allows service providers to set a minimum number of exposures over an interval of time, and a per-user maximum aggregate bid value for meeting the minimum number of exposures within the interval of time.

Document 202 may include any machine-readable content, which may include text, graphics, images, videos, multimedia graphics, etc. Document 202 may be encoded in a markup language, e.g., Hypertext Markup Language (HTML), e.g., a web page rendered in JavaScript or in any other machine readable or executable format. Document 202 may include a hyperlink to another document.

Document 202 may receive device identifier 203 when document 202 is rendered to client computing device 102. Device identifier 203 may be stored by client computing device 102. Device identifier 203 may be included in a user record, e.g., a user profile. Device identifier 203 may associate the information in the user record to a particular user or client computing device 102. A user may opt in or out of allowing data processing system 104 or other content source to identify and store information about the user and/or about devices operated by the user. For example, the user may opt in to receiving digital components from data processing system 104 that may be more relevant to her. In one implementation, the user may be represented as a randomized device identifier (e.g., a cookie, a device serial number, etc.) that contains no personally-identifiable information about the user. For example, information relating to the user's name, demographics, etc., may not be used by a digital component server unless the user opts in to providing such information. Thus, the user may have control over how information is collected about him or her and used by a digital component server or other content source.

In some implementations, device identifier 203 is associated with a particular instance of a client application (e.g., running on client computing device 102). In some implementations, device identifier 203 is associated with a user (e.g., when the user logs in with a username and password). Some information that may be associated with the user may include events, such as one or more queries, one or more clicks, browser history data (e.g., the URLs visited, the number of URLs viewed, URL visit durations, etc.), etc. Events may also include digital component metrics, such as impressions, click through rate, etc. for each user. For example, device identifier 203 may include a time stamp associated with a particular event. Events may also include exposure data 208, e.g., how many times a user is exposed to a particular ad, a campaign, etc. In some implementations, exposure data 208 may include the number of exposures associated with device identifier 203, a time stamp of the exposures (when), and how the exposures occurred (e.g., placement of the digital component, interaction with the digital component, etc.).

A content network may select content to be provided with a webpage based on device identifier 203 for a user visiting document 202. For example, a user may opt in to receiving relevant digital components from a digital component server. Rather than selecting a digital component to be provided on document 202 based on the content of document 202 itself or on other factors, data processing system 104 may take into account device identifier 203 provided as part of a content request. In one example, a user may visit a number of webpages devoted to reviews of golf clubs and later visit a webpage to check stock quotes. Based on the user's visits to the golf-related webpages, the user may be determined to be interested in receiving digital components for golf clubs. When the user later visits the webpage to check stock quotes, an online retailer of golf equipment may seek to include a digital component on the webpage for that particular user, even though the financial webpage is unrelated to golf.

If content is selected based in part on a device identifier for a user that opts in to receiving more relevant content, a content provider may specify that certain content is to be provided to a set of device identifiers. For example, a service provider may identify a set of device identifiers associated with visiting the service provider's website and making a purchase. Such users may later wish to know if the service provider is running a sale. In some cases, a digital component network may identify users on behalf of the service provider that may be interested in receiving digital components from the service provider. For example, service providers may specify a number of topic categories for their digital components and the digital component network may match users' interests to the categories, to provide relevant digital components to the users.

Device identifier 203 may be received by data processing system 104. Data processing system 104 may retrieve exposure data 208. For example, exposure data 208 may include the number of exposures to device identifier 203. Exposure data 208 may also include how recent the exposures were to device identifier 203 or when the exposures occurred.

Data processing system 104 may receive digital component metrics and selection criteria 206. For example, data processing system 104 may receive the total number of different viewers exposed to the digital component (at least once, twice, etc.) during an interval of time, which may be determined by the service provider, publisher, etc. Selection criteria 206 may include demographics, placement, geo-location, etc., which may be determined by the service provider, publisher, etc. Selection criteria 206 may also include budgetary criteria. For example, the service provider may provide a per-user maximum aggregate bid value 210 for meeting the minimum number of exposures. In some implementations, the minimum number of exposures may have to occur within an interval of time. In another implementation, data processing system 104 may store device identifier 203 and exposure data 208.

In some implementations, data processing system 104 stores selection criteria 206. In another implementation, data processing system 104 determines the probability 212 that device identifier 203 will receive the minimum number of exposures within the interval of time and within the maximum aggregate bid value 210, e.g., exposure data 208. Given the probability 212, digital component server may adjust bidding data 214 with the budgetary criteria (e.g., the per-user maximum aggregate bid value).

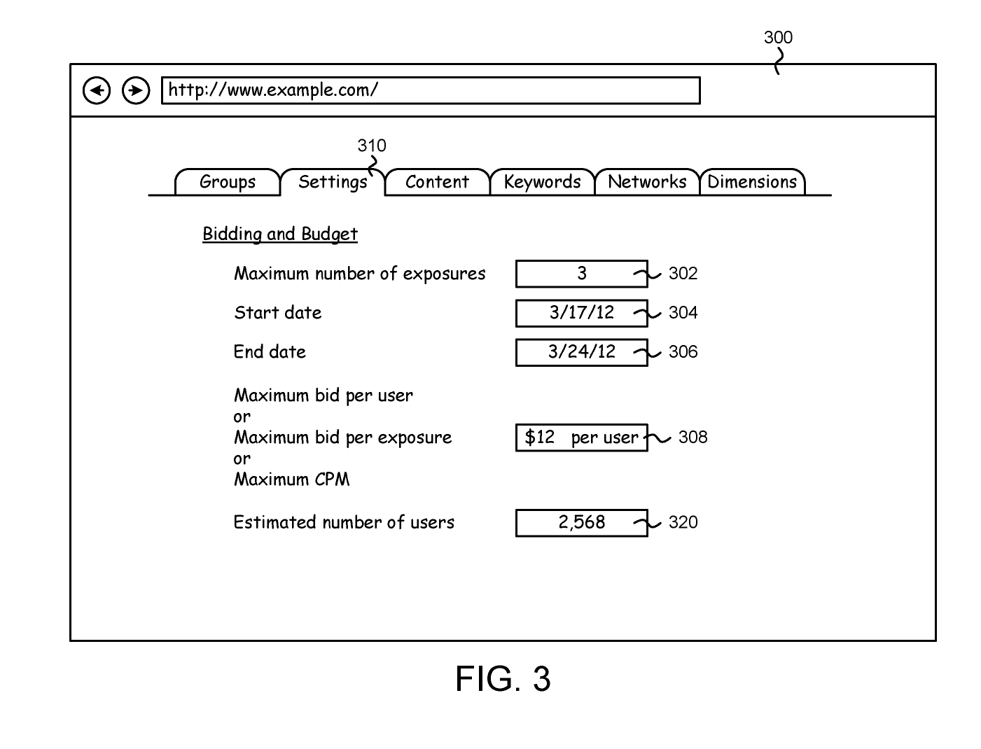

FIG. 3 is an illustration 300 of a user interface that allows the service provider to determine selection criteria. In the example, the service provider may determine the following settings 310, a minimum number of exposures at input field 302, a start date at input field 304, an end date at input field 306, a maximum bid per user, and a maximum bid for exposure, or a maximum CPM (cost per mille) at input field 308. Other variations of the settings may be implemented. Once these settings are entered, the system may determine the estimated number of expected unique users at output field 320.

For example, the service provider may determine that a user needs to view their digital component message three times within a week for the user to be aware of the digital component message, thereby entering three at input field 302, and a start date at input field 304, and an end date at input field 306.

At input field 308, the service provider may determine a maximum aggregate bid value 210 of $12 per user as an appropriate maximum amount to pay for exposing the user to the digital component message for the minimum of three times within one week. The service provider may also enter a maximum bid per exposure or CPM.

At output field 320, the system may automatically estimate the number of expected unique users that the digital component will be exposed to. The service provider can then alter input fields 302-308 to change output field 310.

Data processing system 104 receives selection criteria 206 that may include exposure data 208 of a minimum of three exposures per user within one week. Data processing system 104 may also receive the budgetary criteria that include the maximum aggregate bid value per user of $12.

In the example, data processing system 104 may determine the probability that a user is likely to meet the minimum number of three exposures within one week given selection criteria 206. Data processing system 104 may provide bidding data 214 for each exposure based on the determined probability 212 and the maximum aggregate bid value of $12 per user. If and when the auction is won, the digital component 216 may be provided, while updating device identifier 203 and/or data processing system 104.

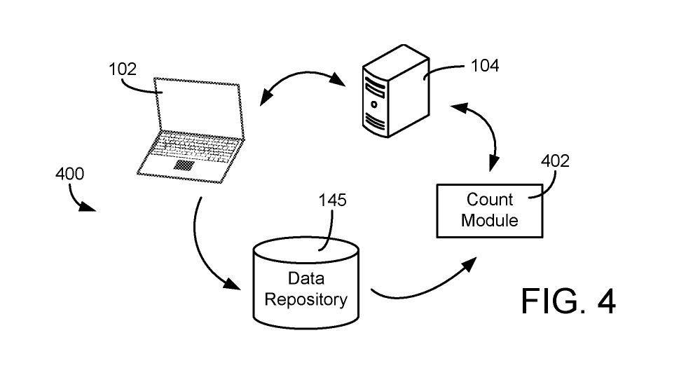

FIG. 4 is an illustration 400 of a system for updating the device identifier in accordance with a described implementation. Illustration 400 may include client computing device 102 including device identifier 203, data processing system 104, count module 402 and data repository 145.

Client computing device 102 may receive a rendered web page along with a digital component from data processing system 104. The digital component may be selected by the service provider as a digital component having a goal for a minimum number of exposures within an interval of time.

Count module 402 receives information from data processing system 104 that the digital component has been provided to client computing device 102. Count module 402 may update the number of exposures. Count module 402 may store the number of exposures as exposure data in data repository 145.

In some implementations, data repository 145 may receive exposure data in order to determine which digital component to generate and provide to data processing system 104. Data repository 145 may include digital components that are tagged with exposure data or data repository 145 may tag the digital components with the exposure data. Data repository 145 may provide the digital components tagged with exposure data to client computing device 102 or to data processing system 104 to be displayed on a web page.

In some implementations, client computing device 102 provides exposure data to data processing system 104 after receiving a rendered document 202 from data processing system 104. In other implementations, Client computing device 102 may provide the exposure data to data repository 145.

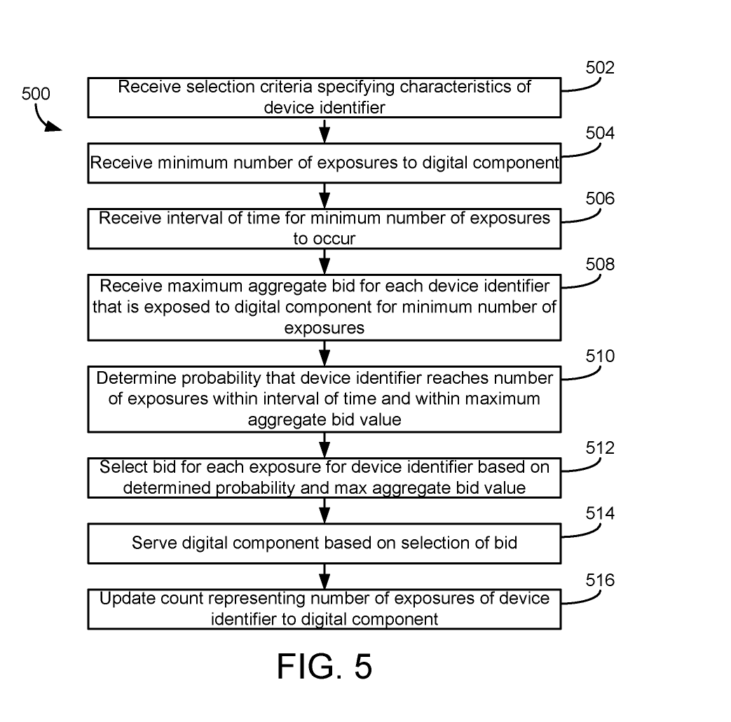

FIG. 5 is an example of a flow diagram of a method 500 to provide a digital component with a minimum number of exposures. Example method 500 may be implemented by various combinations of systems. Example method 500 may be performed online or offline.

Example method may begin at ACT 502, selection criteria to specify the device identifier that meets the selection criteria is received. For example, the selection criteria may define one or more characteristics of the users to which the digital component is directed. If a device identifier has one or more of the defined characteristics, then the device identifier meets the selection criteria. If the device identifier does not include one or more (or at least a threshold number) of the characteristics, then the digital component may not be provided to the device identifier. In some implementations, the selection criteria may include budgetary criteria, e.g., one or more bids.

At ACT 504, a minimum number of exposures to the digital component and an interval of time for the minimum number of exposures to occur is received. In some implementations, the minimum number of exposures is stored in a memory. A maximum aggregate bid value to be paid for each device identifier that is exposed to the digital component for a minimum number of exposures may also be received. In some implementations, the minimum number of exposures and the interval of time includes a frequency, e.g., how many times the digital component is exposed within a set period of time. In some implementations, the interval of time may include a length of time the digital component is exposed, e.g., 1 week. In other implementations, the interval of time may include a time of day when the digital component is exposed.

At ACT 506, a probability that the device identifier reaches the number of exposures within the interval of time and the maximum aggregate bid value is determined. Probability may be determined using a number of methods including, but not limited to, distributed gradient descent and logistic regression.

If there is sufficient historical data for a user, then the application of the desired interval of time and the desired selection criteria are applied to produce a prediction. In this implementation, statistical methods may not be needed. Either the prediction will indicate that the user will meet the minimum number of exposures in the interval of time or not.

If there is not sufficient historical data for a user, then the system may determine by an estimation or a guess whether the user will meet the minimum number of exposures within the interval of time. In an example, the system may receive the historical data that it does have for the user to compare the data to a population of similar users that have sufficient historical data, e.g., any correlated or detectable data may be used. The population of similar users may produce a probability of meeting the minimum number of exposures within the interval of time for the desired selection criteria. This probability is then applied to the newly observed user, e.g., if seventy percent of the similar population would meet the minimum number of exposures, then the 0.7 probability is applied to the newly observed user.

At ACT 508, a bid for each exposure for the device identifier based on the determined probability and the maximum aggregate bid value is selected. When selection criteria are met, then the probability is determined at ACT 510, which may produce a weight used to adjust a bid. The higher the probability, then the higher the bid, with a maximum combination of minimum exposures not exceeding the maximum aggregate bid value.

In some implementations, the probability may be conditional and adjusted based on the number of exposures. For example, a user that is one exposure away from meeting the minimum number of exposures may receive a higher bid than a user that is three exposures away, provided all other criteria is equal. The system may also determine a different probability for each user. A weight may also be determined to select a bid.

At ACT 512, a bid is selected for each exposure for the device identifier based on the determined probability and the maximum aggregate bid value. The weight is the mechanism that can adjust a bid to favor impressions that are more likely to meet the goal minimum number of exposures in the interval of time. In some implementations, the probability may be used as the weight. In this implementation, however, campaign constraints may limit how low or high the weight can be set.

The weight used to adjust a bid may be determined by historical impression data, for each device identifier, while also applying the selection criteria and the interval of time. If there are a sufficient number of impressions to meet the minimum number of exposures, then the bidding weight may be applied. If there is not a sufficient number of impressions, then no bidding weight may be applied. The probability is used to change the bid when the user is close to meeting the minimum number of exposures. In other implementations, the probability may not be used when the user is far from meeting the minimum number of exposures.

In another example, there may not be enough information to determine the probability, because the user is new or there is not enough historical impression data. In these cases, the probability may be determined based on whether similar device identifiers meet the minimum number of exposures within the interval of time. Similar users may be selected based on regression analysis, where user characteristics, such as, but not limited to, browser, operating system, browser history, interests, etc., may determine whether the user will meet the minimum number of exposures. Then, a user model may be constructed along with the probability. The probability from the model may be used to set the bidding weight to bias exposures to users most likely to meet the minimum number of exposures within the interval of time.

At ACT 514, a digital component is served on selection of the bid. In some implementations, serving may include providing display data, which may be indicative of the digital component. The digital component server may provide the display data to the client device. The digital component server may be configured to cause the client to display the digital component. In some implementations, the display data may cause the digital component to be displayed. In other implementations, the display data may include the digital component itself. In yet another implementation, the display data may include a selection of a digital component present on the client device, e.g., the digital component server alerts the client device that there is a selected digital component. The display data may be provided to an interface, e.g., a graphical user interface, a command line interface, etc. At ACT 516, the count is updated representing the number of exposures of device identifier to the digital component, as shown in FIG. 4.

In an alternative implementation, the total number of different users exposed to the digital component message during a given period and how many times they are exposed to the digital component message may be predicted for a content campaign, e.g., using gross rating points or target rating points, which equate to how many times the message aired times the number of users that were exposed to the digital component message. The bid may be adjusted so that the prediction aligns with the minimum number of exposures per user for the total number of users exposed.

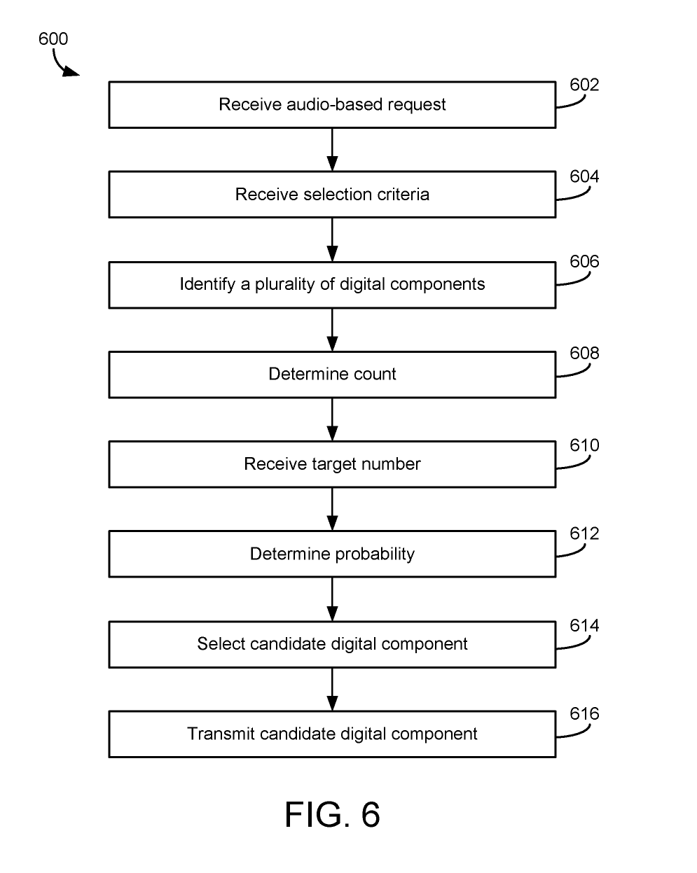

FIG. 6 illustrates a block diagram of an example method 600 to transmit digital components. The method 600 can include receiving an audio-based request (ACT 602). The method 600 can include receiving selection criteria (ACT 604). The method 600 can include identifying a plurality of digital components (ACT 606). The method 600 can include determining a count (ACT 608). The method 600 can include receiving a target number (ACT 610). The method 600 can include determining a probability (ACT 612). The method 600 can include selecting a candidate digital component (ACT 614) and transmitting the candidate digital component (ACT 616).

The method 600 can include receiving an audio-based request (ACT 602). The data processing system can receive the request from a computing device. The audio-based request can include a device identifier that is associated with the computing device. The audio-based request can be detected at the computing device. For example, the audio-based request can be detected at a microphone positioned at or the computing device. In some implementations, the request can be a text-based, image-based, or video-based requests that can be input into the computing device with a physical or digital keyboard or a camera. The request can be included in an input audio signal.

A NLP component 110, that is executed by the data processing system 104, can receive the audio-based request. The NLP component 110 can receive the request via an interface of the data processing system 104. The NLP component 110 can receive the request as a plurality of data packets that can include the audio-based input signal. The data packets can be received at the data processing system, via a network, as packet or other protocol based data transmissions. The request can be encoded as an input audio signal by the computing device that transmits the request to the data processing system 104. For example, the computing device can include a microphone into which a user speaks the request. The computing device can convert the microphone's recording into an input audio signal that is transmitted to the data processing system. The NLP component 110 can identify, in audio-based request, a request and a trigger keyword that can correspond to the request. A direct action application programming interface of the data processing system 104, based on at least one of the request and the trigger keyword, can generate a first action data structure. For example, the NLP component 110 can parse the input audio signal to identify requests that relate to subject matter of the input audio signal, or to identify trigger keywords that can indicate, for example, actions associated with the requests.

The method 600 can include receiving selection criteria (ACT 604). The selection criteria can include device identifier characteristics. The selection criteria can be associated with a digital component. The device identifier characteristics can be an indication of a device identifier. The device identifier characteristics can be characteristics of a computing device the service provider computing device 160 or the content provider computing device 108 is interested having digital components transmitted. The device identifier characteristics can include display screen parameters (e.g., size, resolution), audio parameters, mobile device parameters, (e.g., processing power, battery life, existence of installed apps or programs, or sensor 151 or speaker 154 capabilities), content slots on online documents for text, image, or video renderings of content items, chat applications, laptops parameters, smartwatch or other wearable device parameters (e.g., indications of their display or processing capabilities), or virtual reality headset parameters.

The method 600 can include identifying a plurality of digital components (ACT 606). The plurality of digital components can be associated with the digital component with which the selection criteria are associated. The plurality of digital components can be digital components that are related to the digital component identified in the characteristics. For example, the plurality of digital components can be provided by the same service provider computing device 160, the same content provider computing device 108, or can include the same or related subject matter. The data processing system 104 can identify the plurality of digital components through a lookup table. The related digital components can be stored in a relational database that enables the retrieval of related digital components.

The method 600 can include determining a count (ACT 608). The count can represent a number of the plurality of digital components previously transmitted to the computing device. The data processing system can determine the number of times one of the plurality of digital components was transmitted to the computing device for display on the computing device. The count can represent a number of times the plurality of digital components were transmitted to the computing device within past time interval. For example, the number of times in the last month, week, day, or hour.

The method 600 can include receiving a target number (ACT 610). The target number can indicate a target count for the number of times digital components from the plurality of digital components are to be transmitted to the computing device within a predetermined time interface. The time interval can be an hour, day, week, plurality of weeks, month, or plurality of months.

The method 600 can include determining a probability (ACT 612). The probability can be the probability the count reaches the target number within a predetermined time interval. The probability can be based on the type or characteristic of the digital component. The data processing system can select an exposure model. The data processing system can use the selected exposure model to determine the probability the count reaches the target number. The data processing system can also identify an exposure interval that can be on the selection criteria. The exposure interval can indicate a target amount of time the digital component is displayed to on a computing device. For example, the display or rendering of a digital component can be terminate by a user prior to the digital component being displayed for the length of time indicated by the exposure interval. The second probability can indicate the probability the digital component will be displayed for the full exposure interval prior to the display of the digital component being termination by a user.

In some implementations, the data processing system 104 can determine a second count that indicates the number to times the plurality of digital component were transmitted to a second computing device that is associated with the computing device that transmitted the request to the data processing system. The second computing device can be a computing device that is linked to the computing device that transmitted the request by a common login or by a grouping that is established by the user of the computing device. The data processing system can calculate a second probability that a combination of the count and the second count reaches the target number with the predetermined time interval. The second probability can be the probability that the display of the digital component on the combination of both the computing device and the second computing device reaches the target number.

The method 600 can include selecting a candidate digital component (ACT 614). The data processing system can select the candidate digital component based on the probability and selection criteria. The candidate digital component can be selected based on the probability and the probability that the candidate digital component will be exposed for the predetermined exposure interval. The candidate digital component can be selected based on the probability and the probability that the candidate digital component (or related digital components) are displayed on a combination of the computing device and the second computing device the target number of times. The candidate digital component can be selected by the data processing system based on the first action data structure. In some implementations, the data processing system can determine not to select a digital component as a candidate digital component if the probability is below a predetermined threshold. For example, if the data processing system determines the probability of reaching the target number is low, the data processing system can select to not select and transmit a digital component to the computing device. The data processing system can determine not to transmit a selected digital component to the computing device because the transmission of the digital component would be a waste of computational resources and bandwidth.

The method 600 can include transmitting the candidate digital component (ACT 616). The data processing system can transmit the candidate digital component to the computing device. The data processing system can select to transmit the digital component to a second computing device that is related to the computing device. The data processing system can include an interface management component that can poll a plurality of interfaces to identify a first candidate interface of the computing device and a second candidate interface of a second computing device. The interface management component can determine resource utilization values for each of the candidate interfaces. The resources utilization values can be based on at least one of a battery status, processor utilization, memory utilization, an interface parameter, and network bandwidth utilization. The interface management component can select to transmit the candidate digital component to the computing device based on the first resource utilization value and the second resource utilization value. For example, the data processing system can select to which candidate interface to transmit the digital component based on a comparison of the remaining battery life and interface types (e.g., screen or speaker interfaces) available at each of the first and second candidate interfaces. In some implementations, the data processing system can transmit the digital component to the second candidate interface in place of the first candidate interface. The data processing system can transmit the digital component to both the first and the second candidate interfaces. The candidate interfaces can be interfaces of a single computing device or of multiple, different computing devices. For example, the first candidate interface can be a screen of a first computing device and the second candidate interface can be a speaker of the first computing device. The second candidate interface can be a type of interface a first computing device does not have. For example, a first computing device may not have a screen and second candidate interface can be a screen interface of a second computing device related to the first computing device. In some implementations, the interface management component can determine a distance between each of the plurality of candidate interfaces and the computing device that transmitted the request to the data processing system. The data processing system can select the candidate digital component based on the distance between each of the plurality of candidate interfaces and the computing device. The interfaces can include a display screen, an audio interface, a vibration interface, an email interface, a push notification interface, a mobile computing device interface, a portable computing device application, a content slot on an online document, a chat application, mobile computing device application, a laptop, a watch, a virtual reality headset, and a speaker.

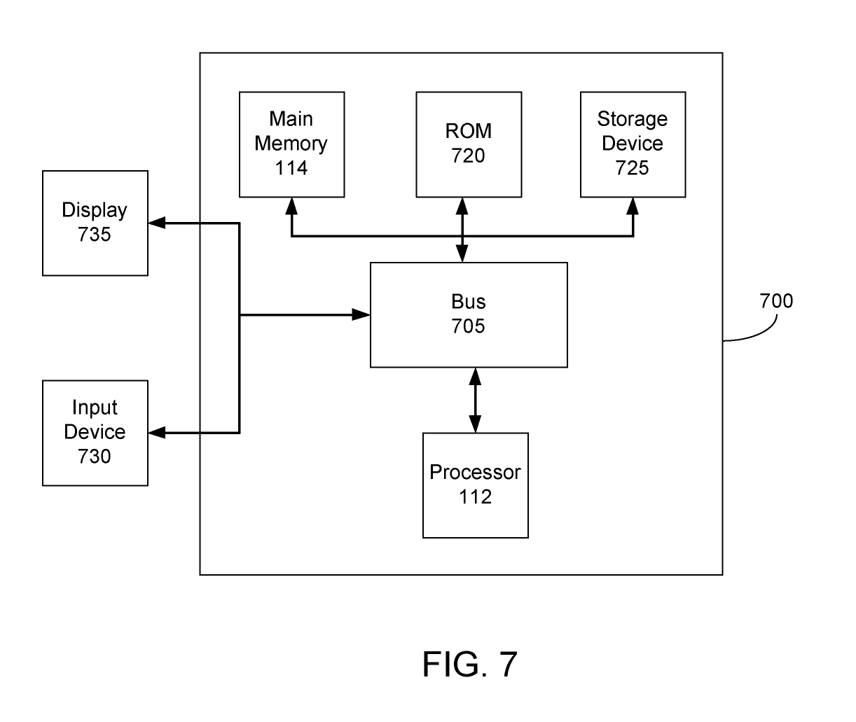

FIG. 7 is a block diagram of an example computer system 700. The computer system or computing device 700 can include or be used to implement the system 100, or its components such as the data processing system 104. The computing system 700 includes a bus 705 or other communication component for communicating information and a processor 710 or processing circuit coupled to the bus 705 for processing information. The computing system 700 can also include one or more processors 710 or processing circuits coupled to the bus for processing information. The computing system 700 also includes main memory 715, such as a random access memory (RAM) or other dynamic storage device, coupled to the bus 705 for storing information, and instructions to be executed by the processor 710. The main memory 715 can be or include the data repository 145. The main memory 715 can also be used for storing position information, temporary variables, or other intermediate information during execution of instructions by the processor 710. The computing system 700 may further include a read only memory (ROM) 720 or other static storage device coupled to the bus 705 for storing static information and instructions for the processor 710. A storage device 725, such as a solid state device, magnetic disk or optical disk, can be coupled to the bus 705 to persistently store information and instructions. The storage device 725 can include or be part of the data repository 145.

The computing system 700 may be coupled via the bus 705 to a display 735, such as a liquid crystal display, or active matrix display, for displaying information to a user. An input device 730, such as a keyboard including alphanumeric and other keys, may be coupled to the bus 705 for communicating information and command selections to the processor 710. The input device 730 can include a touch screen display 735. The input device 730 can also include a cursor control, such as a mouse, a trackball, or cursor direction keys, for communicating direction information and command selections to the processor 710 and for controlling cursor movement on the display 735. The display 735 can be part of the data processing system 104, the client computing device 102 or other component of FIG. 1A and FIG. 1B, for example.

The processes, systems and methods described herein can be implemented by the computing system 700 in response to the processor 710 executing an arrangement of instructions contained in main memory 715. Such instructions can be read into main memory 715 from another computer-readable medium, such as the storage device 725. Execution of the arrangement of instructions contained in main memory 715 causes the computing system 700 to perform the illustrative processes described herein. One or more processors in a multi-processing arrangement may also be employed to execute the instructions contained in main memory 715. Hard-wired circuitry can be used in place of or in combination with software instructions together with the systems and methods described herein. Systems and methods described herein are not limited to any specific combination of hardware circuitry and software.

Although an example computing system has been described in FIG. 7, the subject matter including the operations described in this specification can be implemented in other types of digital electronic circuitry, or in computer software, firmware, or hardware, including the structures disclosed in this specification and their structural equivalents, or in combinations of one or more of them.

For situations in which the systems discussed herein collect personal information about users, or may make use of personal information, the users may be provided with an opportunity to control whether programs or features that may collect personal information (e.g., information about a user's social network, social actions or activities, a user's preferences, or a user's location), or to control whether or how to receive content from a content server or other data processing system that may be more relevant to the user. In addition, certain data may be anonymized in one or more ways before it is stored or used, so that personally identifiable information is removed when generating parameters. For example, a user's identity may be anonymized so that no personally identifiable information can be determined for the user, or a user's geographic location may be generalized where location information is obtained (such as to a city, postal code, or state level), so that a particular location of a user cannot be determined. Thus, the user may have control over how information is collected about him or her and used by the content server.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices). The operations described in this specification can be implemented as operations performed by a data processing apparatus on data stored on one or more computer-readable storage devices or received from other sources.

The terms “data processing system” “computing device” “component” or “data processing apparatus” encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures. The interface management component 140, direct action API 135, content selector component 125, prediction component 120 or NLP component 110 and other data processing system 104 components can include or share one or more data processing apparatuses, systems, computing devices, or processors.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs (e.g., components of the data processing system 104) to perform actions by operating on input data and generating output. The processes and logic flows can also be performed by, and apparatuses can also be implemented as, special purpose logic circuitry, e.g., an FPGA (field programmable gate array) or an ASIC (application-specific integrated circuit). Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back-end component, e.g., as a data server, or that includes a middleware component, e.g., an application server, or that includes a front-end component, e.g., a client computer having a graphical user interface or a web browser through which a user can interact with an implementation of the subject matter described in this specification, or a combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system such as system 100 or system 700 can include clients and servers. A client and server are generally remote from each other and typically interact through a communication network (e.g., the network 106). The relationship of client and server arises by virtue of computer programs running on the respective computers and having a client-server relationship to each other. In some implementations, a server transmits data (e.g., data packets representing action data structures or content items) to a client device (e.g., to the client computing device 102 for purposes of displaying data to and receiving user input from a user interacting with the client device, or to the service provider computing device 160 or the content provider computing device 108). Data generated at the client device (e.g., a result of the user interaction) can be received from the client device at the server (e.g., received by the data processing system 104 from the computing device 102 or the content provider computing device 108 or the service provider computing device 160).

While operations are depicted in the drawings in a particular order, such operations are not required to be performed in the particular order shown or in sequential order, and all illustrated operations are not required to be performed. Actions described herein can be performed in a different order.

The separation of various system components does not require separation in all implementations, and the described program components can be included in a single hardware or software product. For example, the NLP component 110, the content selector component 125, the interface management component 140, or the prediction component 120 can be a single component, app, or program, or a logic device having one or more processing circuits, or part of one or more servers of the data processing system 104.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

The systems and methods described herein may be embodied in other specific forms without departing from the characteristics thereof. The foregoing implementations are illustrative rather than limiting of the described systems and methods. Scope of the systems and methods described herein is thus indicated by the appended claims, rather than the foregoing description, and changes that come within the meaning and range of equivalency of the claims are embraced therein.

1.-20. (canceled)

21. A system to provide content to computing devices in an online computer network environment, comprising a data processing system to:
receive an audio-based request from a computing device, the audio-based request comprising a device identifier associated with the computing device and the audio-based request detected at the computing device;
receive selection criteria comprising device identifier characteristics and the selection criteria associated with a digital component;
identify a plurality of digital components associated with the digital component;
determine a count representing a number of the plurality of digital components previously transmitted to the computing device;
receive a target number of the plurality of digital components previously transmitted to the computing device;
determine a probability the count reaches the target number within a predetermined time interval;
select a candidate digital component based on the probability and selection criteria; and
transmit the candidate digital component to the computing device.

22. The system of claim 21, comprising the data processing system to:
select, based on the selection criteria, an exposure model; and
determine, by the exposure model, the probability the count reaches the target number.

23. The system of claim 21, comprising the data processing system to:
identify an exposure interval based on the selection criteria;
determine a second probability the computing device displays the candidate digital component from the exposure interval; and
select the candidate digital component based on the second probability.

24. The system of claim 21, comprising:
a natural language processor component to:
receive, via an interface of the data processing system, data packets comprising the audio-based request;
identify, from the audio-based request, a request and a trigger keyword corresponding to the request;
a direct action application programming interface to generate, based on at least one of the request and the trigger keyword, a first action data structure; and
a content selector component to select the candidate digital component based on the first action data structure.

25. The system of claim 21, comprising an interface management component to:
poll a plurality of interfaces to identify a first candidate interface of the computing device and a second candidate interface of a second computing device;
determine a first resource utilization value for the first candidate interface and a second resource utilization value for the second candidate interface, the first resource utilization value and the second resource utilization value based on at least one of a battery status, processor utilization, memory utilization, an interface parameter, and network bandwidth utilization; and
select to transmit the candidate digital component to the computing device based on the first resource utilization value and the second resource utilization value.

26. The system of claim 21, comprising an interface management component to:
poll a plurality of interfaces to identify a first candidate interface of the computing device and a second candidate interface of a second computing device;
transmit the candidate digital component to the second computing device.

27. The system of claim 21, comprising:
an interface management component to:
poll a plurality of interfaces to identify a first candidate interface of the computing device and a second candidate interface of a second computing device;
transmit, responsive to a second probability being above a predetermined threshold, the candidate digital component to the second computing device;
the data processing system to:
determine a second count of a number of the plurality of digital components previously transmitted to the second computing device; and
determine the second probability a combination of the count and the second count reaches the target number with the predetermined time interval.

28. The system of claim 21, comprising an interface management component to:
poll a plurality of interfaces of the computing device;
select, based on a resource utilization value of plurality of interfaces, a candidate interface; and
transmit the candidate digital component to the candidate interface of the computing device.

29. The system of claim 28, wherein the plurality of interfaces includes at least one of a display screen, an audio interface, a vibration interface, an email interface, a push notification interface, a mobile computing device interface, a portable computing device application, a content slot on an online document, a chat application, mobile computing device application, a laptop, a watch, a virtual reality headset, and a speaker.

30. The system of claim 21, comprising an interface management component to:
poll a plurality of candidate interfaces associated with the computing device;
determine a distance between each of the plurality of candidate interfaces and the computing device; and
select the candidate digital component based on the distance between each of the plurality of candidate interfaces and the computing device.

31. A method to provide content to computing devices in an online computer network environment, comprising:
receiving, by a data processing system, an audio-based request from a computing device, the audio-based request comprising a device identifier associated with the computing device and the audio-based request detected at the computing device;
receiving, by the data processing system, selection criteria comprising device identifier characteristics and the selection criteria associated with a digital component;
identifying, by the data processing system, a plurality of digital components associated with the digital component;
determining, by the data processing system, a count representing a number of the plurality of digital components previously transmitted to the computing device;
receiving, by the data processing system, a target number of the plurality of digital components previously transmitted to the computing device;
determining, by the data processing system, a probability the count reaches the target number within a predetermined time interval;
selecting, by the data processing system, a candidate digital component based on the probability and selection criteria; and
transmitting, by the data processing system, the candidate digital component to the computing device.

32. The method of claim 31, comprising:
selecting, based on the selection criteria, an exposure model; and
determining, by the exposure model, the probability the count reaches the target number.

33. The method of claim 31, comprising:
identifying an exposure interval based on the selection criteria;
determining a second probability the computing device displays the candidate digital component from the exposure interval; and
selecting the candidate digital component based on the second probability.

34. The method of claim 31, comprising:
receiving, by a natural language processor component executed by the data processing system, via an interface of the data processing system, data packets comprising the audio-based request;
identifying, by the natural language processor component, from the audio-based request, a request and a trigger keyword corresponding to the request;
generating, by a direct action application programming interface of the data processing system, based on at least one of the request and the trigger keyword, a first action data structure; and
selecting, by a content selector component, the candidate digital component based on the first action data structure.

35. The method of claim 31, comprising:
polling, by an interface management component of the data processing system, a plurality of interfaces to identify a first candidate interface of the computing device and a second candidate interface of a second computing device;
determining, by the interface management component, a first resource utilization value for the first candidate interface and a second resource utilization value for the second candidate interface, the first resource utilization value and the second resource utilization value based on at least one of a battery status, processor utilization, memory utilization, an interface parameter, and network bandwidth utilization; and
selecting, by the interface management component, to transmit the candidate digital component to the computing device based on the first resource utilization value and the second resource utilization value.

36. The method of claim 31, comprising:
polling, by the interface management component of the data processing system, a plurality of interfaces to identify a first candidate interface of the computing device and a second candidate interface of a second computing device;
transmitting, by the interface management component, the candidate digital component to the second computing device.

37. The method of claim 31, comprising:
polling, by the interface management component of the data processing system, a plurality of interfaces to identify a first candidate interface of the computing device and a second candidate interface of a second computing device;
determining, by the data processing system a second count of a number of the plurality of digital components previously transmitted to the second computing device;
determining, by the data processing system, a second probability a combination of the count and the second count reaches the target number with the predetermined time interval;
transmitting, responsive to the second probability being above a predetermined threshold and by the interface management component, the candidate digital component to the second computing device.

38. The method of claim 31, comprising:
polling, by an interface management component, a plurality of interfaces of the computing device;
selecting, based on a resource utilization value of plurality of interfaces, a candidate interface; and
transmitting the candidate digital component to the candidate interface of the computing device.

39. The method of claim 38, wherein the plurality of interfaces includes at least one of a display screen, an audio interface, a vibration interface, an email interface, a push notification interface, a mobile computing device interface, a portable computing device application, a content slot on an online document, a chat application, mobile computing device application, a laptop, a watch, a virtual reality headset, and a speaker.

40. The method of claim 31, comprising:
polling, by an interface management component, a plurality of candidate interfaces associated with the computing device;
determining, by the interface management component, a distance between each of the plurality of candidate interfaces and the computing device; and
selecting, by the interface management component, the candidate digital component based on the distance between each of the plurality of candidate interfaces and the computing device.
